(19) United States
(12) Patent Application Publication
(10) Pub. No.: US 2007/0250371 A1
(43) Pub. Date: Oct. 25, 2007

(54) Automated system for task billing

(75) Inventor: Joel Wayne Benson, Lincolnshire, IL (US)

Correspondence Address: BRINKS HOFER GILSON & LIONE, P.O. BOX 10395, CHICAGO, IL, 60610, US

(73) Assignee: Brinks Hofer Gilson & Lione

(21) Appl. No.: 11/406,922

(22) Filed: Apr. 18, 2006

(51) Int. Cl. G06F 15/02

(52) U.S. Cl. 705/9

(57) ABSTRACT

An automated system for implementing task billing for preparing patent applications and responding to Office Actions of the United States Patent and Trademark Office.

### BACKGROUND

1. Technical Field

The invention relates to an automated system wherein accounting and docketing departments of a law firm coordinate their activities in response to automated messages in order to selectively hold and bill time charges and disbursements to accomplish event or task billing. More particularly, the invention concerns an automated computer system which selectively controls the time at which charges for defined tasks are billed to a client.

2. Background Information

Law firms traditionally charge their clients for predefined legal services based upon the amount of time expended by attorneys at various billing rates, as required to provide the services. Typically, a legal service for a particular matter is assigned a unique case number and the attorneys working on that case number report the time they expend for tasks related to the case number over a designated billing period, for example a month. Each attorney has an associated hourly billing rate and that rate multiplied by the number of hours expended for a particular case number defines the dollar amount charged for the attorney's time for that case number over the billing period. Expenses or disbursements associated with any given case number are also accumulated over a billing period with the accumulated charges of attorneys and a bill is provided each month for a client to cover the accumulated attorney fees and disbursements.

Typically clients will pay each month for the accumulated attorney fees and disbursements for that month. Clients therefore pay for particular legal tasks cumulatively over time as the attorneys work on the tasks. From the client's prospective, this method of cumulative payment for particular tasks has the disadvantage that it does not necessarily motivate attorneys to complete their tasks relatively quickly and efficiently.

Many clients in recent years have therefore required their attorneys to charge for services on an “event or task” basis. That is, clients have required that certain tasks not be billed by the law firm until the task is completed. If a task takes longer than a billing period, for example a month, it is then necessary for the law firm to hold and not bill disbursements and attorney fees that accumulate as the task is being performed, for example over multiple billing periods. When the task is completed, all the attorney fees and disbursements accumulated for that task are released and billed to the client.

Law firms have had considerable difficulty in adjusting their traditional systems for billing to accommodate event or task billing requirements of their clients. Some attorneys have attempted to accommodate task billing by personally instructing accounting department personnel when to hold or release attorney fees and disbursements for particular tasks associated with a project case number. This approach to controlling task billing is ineffective, for example when an attorney is responsible for hundreds of cases, where each case has associated multiple tasks and different attorneys performing those tasks.

As an example, an intellectual property law firm of even modest size will have hundreds of case numbers, each associated with a particular patent application that is being prepared or prosecuted by attorneys of the law firm. If, for example, a client defines preparing a patent application, responding to Office Actions of the United States Patent and Trademark Office (PTO) for that application, and filing appeals within the PTO as separate tasks, the law firm must keep track of the current status of hundreds of patent applications with respect to each of these tasks and control the billing of fees and disbursements accordingly. Managing task billing for so many events is challenging and does not lend itself to typical manual accounting and docketing operations.

Accordingly, it would be advantageous to provide a billing system that can automatically hold fees and disbursements during the pendency of a task and automatically bill those accumulated fees and disbursements when the task is completed.

It would also be advantageous to provide such an automated task billing system that uses traditional accounting and docketing operations of an intellectual property law firm in a manner that achieves reliable and efficient task billing results.

### BRIEF SUMMARY

The invention concerns the use of traditional docketing and accounting procedures and equipment to achieve an automatic and reliable task billing system. The system of the invention is implemented by defining particular tasks associated with projects having assigned case numbers. The initiation of any given task is associated with a corresponding automated event in docketing and, when that event occurs, an automated “hold billing” command is sent from docketing to an accounting system which will then hold billing for fees and disbursements associated with a case number project for the initiated task. A docketing event is then defined to register the end of a particular task and automatically instruct the accounting system to release the held fees and disbursements associated with the case number for that completed task. The accumulated fees and disbursements for the completed task are then billed to the client in the next billing cycle.

The automated system of the invention therefore operates automatically and efficiently to hold billing when tasks are started and to release the billing to the client when tasks are completed.

### BRIEF DESCRIPTION OF THE DRAWINGS

FIG. 1 is a flow chart of steps for implementing task billing with respect to the preparation of a patent application.

FIG. 2 is a flow chart of steps for implementing task billing for responding to Office Actions associated with a patent application.

FIG. 3 is a flow chart of steps for implementing task billing with respect to notices of abandonment sent to the PTO or received from the PTO.

### DETAILED DESCRIPTION OF THE DRAWINGS AND THE PRESENTLY PREFERRED EMBODIMENTS

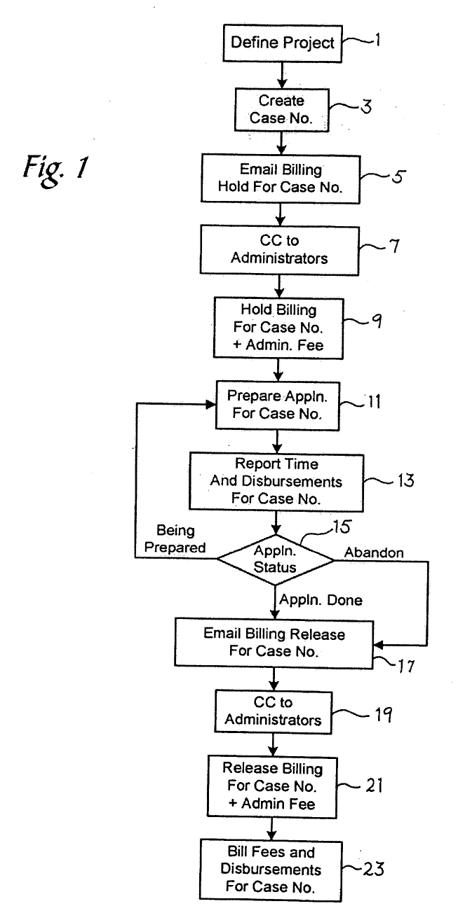

FIG. 1 illustrates a flow chart of steps that implement a task billing system for the preparation of patent applications. In this system it is assumed the patent application has an assigned case number that uniquely defines the application and its associated invention. The case number is used by accounting and docketing functions of an intellectual property law firm to keep track of billing associated with attorney fees and disbursements for the application and events associated with preparation and prosecution of the application in order to obtain a patent.

In a preferred embodiment of the invention, IP Master Version 1.61a docketing software provided by Master Data, a Thomson business of Southfield, Mich. is used to keep track of the status of patent applications identified by case numbers. This docketing system when operated with SQL database trigger events programmed in a manner known in the art for database management, has the capability of generating automatic e-mail communications in response to specified docketing events. This automated e-mail capability is particularly useful for implementing the event billing system of the invention.

A preferred embodiment of the event billing system also utilizes an accounting system that is implemented by Win LMS software provided by The Minicomputer Company of Hunt Valley, Md. and Select SA of Timonium, Md. This system allows fees and disbursements associated with a particular defined case number to be held and therefore not billed and to be selectively released for billing by selectively turning on or off a “contingent fee” flag. This capability is significant in achieving an automated event billing system in accordance with the invention.

The program steps of FIG. 1 will hereinafter be discussed with respect to a “task” that is defined as the preparation of a patent application. In operation of the system of the invention, this task is defined when a unique case number is created to correspond to a new patent application, a new continuation application or a new divisional application.

When a case number is created for any such new application, that case number is reported to the docketing department which creates a docket file for the new case number. At the time this docket file is created, the software of the docket system is programmed in a manner known to the art to automatically send an e-mail to a designated person in an accounting department to advise that person a new application file has been created and the beginning of the application preparation task has occurred. The automated e-mail instructs the accounting person to place a hold on all fees and disbursements associated with the new case number. The accounting person therefore manually activates a billing hold for the case number. While it would be possible to automatically initiate a billing hold in accounting in response to creation of a case number in docketing, it is believed safer to introduce a human being in this process in order to ensure that the accounting hold is properly placed. Also, it should be understood that a different trigger event could initiate the billing hold. For example, a docketing person could send the “hold billing” email to accounting when a new disclosure is received from a client and assigned a matter number, but before the new matter number is entered in docketing.

With reference to FIG. 1, a new patent application project is defined at step 1, for example when a new invention disclosure is received by the law firm or when it is decided to prepare a continuation or divisional application associated with a pre-existing disclosure. As shown at step 3, a unique case number is defined for the new application and at step 5 an e-mail is automatically sent from the docketing department to the accounting department to instruct accounting to hold billing for fees and disbursements associated with the case number for the new patent application. At step 7, the e-mail to accounting can be automatically copied to selected administrators who are assigned to keep track of the implementation of billing holds and releases.

At step 9, as previously noted, accounting then automatically holds fees and disbursements which may be generated for the new case number and accounting may also automatically charge an administration fee to the client for implementing this hold for the associated case number.

In the ordinary course of events, an attorney will begin to prepare the new patent application at step 11 and at step 13 will report his time and disbursements to accounting as he progresses. It should be appreciated that the billing attorney for the designated case number does not need to be aware of the implementation of an event billing system. That attorney reports his time in the usual manner and incurs disbursements without regard to operation of the task billing system.

Step 15 is provided to illustrate the logic flow of the event billing system as the patent application is prepared. As noted with respect to step 15, the system loops as the application is being prepared. When the application is completed or if an abandon instruction is received from the client, an automatic release e-mail is sent at step 17 by docketing to accounting in response to the abandon instruction or filing of the application.

That is, when the docket department receives the application for filing, a docket clerk enters the status of the application as “filed” and the docket system automatically sends the e-mail for the case number of the application, instructing the accounting department to release the associated fees and disbursements for billing with respect to the case number. If an instruction to abandon is received from the client, the docket clerk closes the application file in the docketing system and therefore triggers the billing release e-mail for accounting. At step 19, the release e-mail is automatically copied to various administrators who keep track of the release of billing in response to the end of an event, which is here defined as filing the patent application or receiving an instruction to cease preparing the application.

At the next step 21, the accounting system automatically releases the reported fees and disbursements for the case number corresponding to the filed or closed patent application, and may also charge an associated administrative fee for releasing the accounting information for billing.

At step 23, the accumulated fees and disbursements are billed for the completed patent application in the next billing cycle for the client. It should be appreciated that the task billing system of FIG. 1 will be implemented essentially automatically for any new applications that are initiated, prepared and filed or closed. The clients for any such applications which may be numbered in the hundreds or thousands at any particular time, will each be billed only when their patent application task is completed. The law firm will have a series of automated e-mails which can be used to track the operation of the task billing system for any particular patent application. All of this occurs without requiring the intervention of an attorney and the associated loss of billing time for administrative functions implementing task billing.

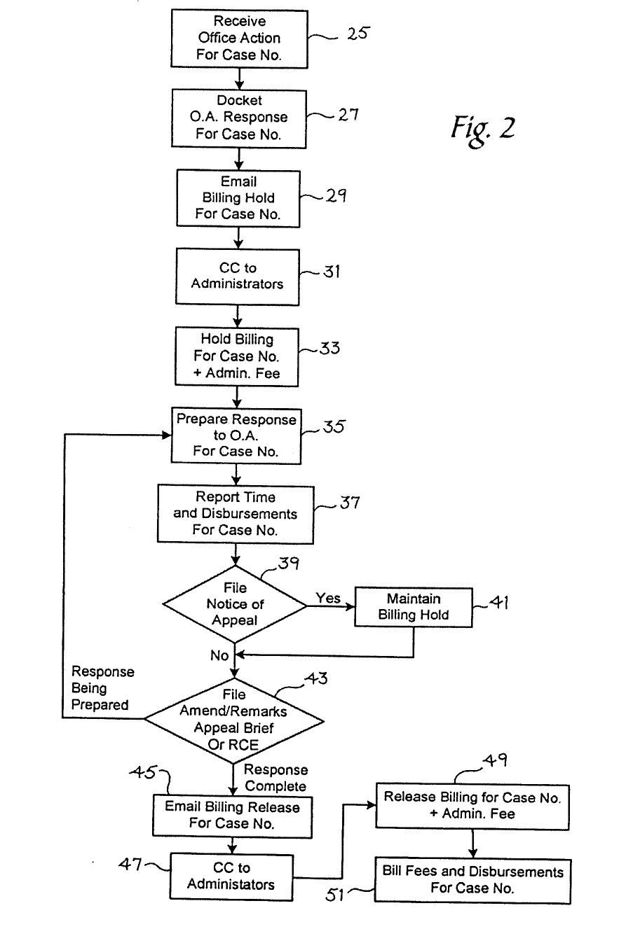

FIG. 2 illustrates the steps of the task billing system associated with responding to Office Actions from the PTO. In this situation the task is defined to begin when an Office Action is received and to end when an action is taken in response to the Office Action. For example, the task would be defined between the time the Office Action is received and the time at which an Amendment or Remarks are filed with the PTO in response to the Office Action. Another task could be defined between the time the Office Action is received and the time an associated Appeal Brief or a Request for Continued Examination (RCE) is filed in response to the Office Action.

With reference to FIG. 2, step 25 corresponds to the time at which an Office Action is received by the docket department of a law firm for an existing case number. In that situation, the docket department will note in its software that the Office Action is received at step 27 and at step 29 the docket software will automatically send an e-mail instructing accounting to hold billing for fees and disbursements associated with the application case number for the Office Action. At step 31, the e-mail is automatically copied to selected administrators that keep track of hold billing instructions.

At step 33, as noted previously, accounting will hold the fees and disbursements for the case number associated with the e-mail from docketing and may automatically charge an administration fee for applying the hold command.

At step 35, the attorney prepares a response to the Office Action for the associated case number and at step 37 the attorney reports his time and disbursements for this activity, as usual.

Step 39 tests whether the attorney has filled a notice of appeal with respect to the Office Action. As shown, if this occurs, the hold on billing is either maintained at step 41 or is initiated by a hold billing e-mail automatically sent by docketing in response to filing of the notice of appeal. The next step 43 determines if an Amendment or Remarks are filed in response to the Office Action, or if an Appeal Brief or RCE are filed. In the absence of a response to the Office Action, the attorney continues to report his time and disbursements as previously noted.

If the attorney completes his prosecution task with an Amendment or Remarks in response to the Office Action, an Appeal Brief or an RCE, he submits any such papers to docketing and a docket clerk makes a corresponding notation in the docket computer system. Thereafter, at step 45, the docket system automatically sends an e-mail to accounting to instruct accounting to release the fees and disbursements associated with the case number for the completed prosecution task, for billing in the next billing cycle. As shown at step 47, this e-mail is automatically copied to selected administrators who monitor the release of held time and at step 49 accounting releases the reported time and disbursements and may automatically apply a billing charge for implementing the release. At step 51, the fees and disbursements associated with the response to the Office Action are billed at the end of the next billing cycle.

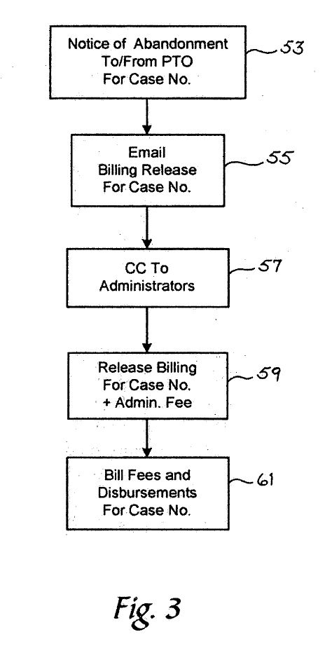

FIG. 3 illustrates the steps for implementing the automatic task billing system in response to an instruction to abandon from a client or a notice of abandonment that is either sent to the PTO or received from the PTO for a particular case number. As shown at step 53, if the notice of abandonment is sent or received, the docket department will make a corresponding entry in the computerized docket system and, as shown at step 55, an e-mail will be automatically sent to accounting to instruct accounting to release the fees and disbursements associated with the corresponding abandoned application. At step 57, this e-mail is automatically copied to associated selected administrators and at step 59 the accounting department automatically releases reported time and disbursements for billing and may charge an associated administrative fee for the release. At step 61 the released fees and disbursements are billed in the next billing cycle.

A preferred automated task billing system has been disclosed with respect to certain tasks and associated trigger events that may be defined for billing legal services and disbursements in an intellectual property firm. It should be understood other types of tasks and associated trigger events could be defined in a similar manner to control task billing for any general law firm for any business that provides services and bills for those services as tasks are completed. It is therefore intended that the foregoing detailed description be regarded as illustrative rather than limiting, and that it be understood the following claims, including all equivalents, are intended to define the full scope of the invention.

1. A task billing system, comprising:
accounting software operated by an accounting department for automatically accumulating fees for time and charges for disbursements for an associated project case number, not billing said fees and charges in response to a hold condition, and selectively releasing the hold condition for billing said fees and disbursements for the case number; and
docketing software operated by a docketing department for noting the beginning and ending of predefined tasks for an associated case number, with means for automatically forwarding to said accounting department a communication for initiating said hold condition at the beginning of a predefined task and releasing the hold at the end of that task.

2. The task billing system of claim 1, wherein said predefined task is preparation of a patent application, the hold condition being defined when the docketing software records a new case number for the application; and the associated release being defined when the docketing software records filing of the application.

3. The task billing system of claim 2, wherein the hold condition is released in response to abandonment of the application.

4. The task billing system of claim 1, wherein said predefined task is preparation of a response to an Office Action, the hold condition being defined when the docketing software records receipt of an Office Action; and the associated release being defined when the docketing software records filing of a response to the Office Action.

5. The task billing system of claim 4, wherein said response is an Amendment.

6. The task billing system of claim 4, wherein said response is an Appeal.

7. The task billing system of claim 4, wherein said response is filing an RCE.

8. The task billing system of claim 4, wherein the hold condition is released in response to abandonment of the application.

9. A method for task billing comprising the steps of:
defining a task that requires billing time and disbursements to complete;
defining a start event by which said task is initiated;
defining an end event by which said task is completed;
docketing said start event when it occurs and automatically generating a hold billing command;
docketing said end event when it occurs and automatically generating a release billing command;
receiving said hold billing command and accumulating billing time and disbursements for said task without billing the time and disbursements; and
receiving said release billing command and billing the accumulated billing time and disbursements for said task.

10. The method claim 9, wherein said task is preparing a patent application.

11. The method of claim 10, wherein said start event is a docket event after which the patent application is prepared.

12. The method of claim 10, wherein said end event is filing the patent application in the PTO.

13. The method of claim 10, wherein said end event is abandonment of the patent application.

14. The method of claim 9, wherein said hold billing command and release billing command are e-mails.

15. The method of claim 9, wherein said task is preparation of a response to an Office Action.

16. The method of claim 15, wherein said start event is receipt of said Office Action.

17. The method of claim 15, wherein said end event is filing an Amendment.

18. The method of claim 15, wherein said end event is filing an Appeal.

19. The method of claim 15, wherein said end event is filing an RCE.

20. The method of claim 15, wherein said end event is abandonment of the patent application.
